(19) United States
(12) Patent Application Publication
(10) Pub. No.: US 2022/0043487 A1
(43) Pub. Date: Feb. 10, 2022

(54) PORTABLE WORKSTATION COVER

(71) Applicant: Sheiner Engineering & Design, LLC, Newark, NJ (US)

(72) Inventor: BRANDON MICHAEL SHEINER, Newark, NJ (US)

(21) Appl. No.: 17/395,336

(22) Filed: Aug. 5, 2021

Related U.S. Application Data
(60) Provisional application No. 63/063,250, filed on Aug. 8, 2020.

(51) Int. Cl. G06F 1/16

(52) U.S. Cl. CPC G06F 1/1656; G06F 1/1686

(57) ABSTRACT

Provided are portable workstation covers comprising a frame of interconnected panels which define an interior volume and a resilient support member received within a retaining sleeve. Related methods of and use are further provided.

### CROSS-REFERENCE TO RELATED APPLICATIONS

This application claims priority to and the benefit of U.S. Provisional Application Ser. No. 63/063,250, which was filed on Aug. 8, 2020, the contents of which is hereby incorporated by reference in its entirety.

### BACKGROUND

For many people, laptop computers are an essential tool. Since their inception, laptop computers have evolved and improved to have increased computing power, longer battery life, and a variety of wireless technology options for sending and receiving data. As a result of these technological advancements, laptop users are able to enjoy using their laptop nearly anywhere they can carry it, including outdoors. More recently, working remotely has become increasingly widespread, and the portability of laptop computers has become even more central to many people.

A basic limitation of laptop computers, is that the temperature of the equipment must be kept within an acceptable range. If the equipment is not kept below an acceptable maximum temperature threshold, the equipment can overheat and result in a variety of performance issues. For example, if left unchecked overheating can cause permanent and irreparable damage to the computer's hardware. When taking a laptop outdoors, a user must be especially careful to ensure the laptop is kept shaded and out of prolonged exposure to the sun or risk overheating the computer. However, shaded areas may not always be available while outdoors. This limitation creates a barrier to enjoying the outdoors and, in effect, limits the portability of laptop computers.

Additionally, when screen-containing devices are used outdoors, sunlight reflecting from the screen can produce a glare, prompting a user to increase brightness of the screen. This, however, exacerbates the potential of overheating, while also speeding the battery drain of the device. Without substantially altering the brightness of the screen, the contents of the screen become difficult to discern and may also lead to eye strain and fatigue.

Additionally, as industry acceptance for remote working continues to increase, other issues related to work portability have presented themselves, such as scanning a document in the absence of a true scanner. Using a camera, such as those on smart phones, a person can take a high-quality photo of a document to digitally capture the documents contents, which are commonly accepted in place of an official scanned document. However, unlike a document that is scanned using a typical office scanner, the photos taken by users often result in the document appearing askew and with inconsistent lighting, which can adversely affect the legibility and presentability of the photo.

Thus, there is a need in the art to provide a product to allow users the ability of more freely using their laptops outdoors without needing to choose between shaded area or the risk of overheating their machine. There is further need for such a product capable of shielding a laptop computer from direct sunlight while still being lightweight, portable and easily manufactured. There is further need for a product that is capable of shielding a laptop computer, while also allowing proper ventilation of the computer. Moreover, there is a need for a product that allows a user to easily position a camera above a document such that the camera lens is parallel with a document to facilitate high quality and legible photos of said documents.

### SUMMARY

Accordingly, provided herein are portable workstation covers for use with electronic devices, e.g., laptop computers, which allow users the ability of more freely using their laptops outdoors without needing to choose between shaded area or the risk of overheating their machine. Further provided herein are products capable of shielding a laptop computer from direct sunlight while still being lightweight, portable and easily manufactured. Further provided herein are products capable of shielding a laptop computer, or other such electronic devices containing a screen, while also allowing proper ventilation of the computer. Moreover, provided herein are products that allow a user to easily position a camera above a document such that the camera lens is parallel with a document to facilitate high quality and legible photos of said documents.

In a first aspect, the present disclosure is directed to a portable workstation cover [Cover 1] comprising:

a series of interconnected panels comprising:
two oppositely positioned side panels,
a top panel and oppositely positioned to a base panel connected to the side panels, and
a rear panel connected to each of the side panels, the top panel and the base panel; at least one resilient support member received within at least one retaining sleeve; wherein the side panels, top panel, base panel and rear panel together define an interior volume, and wherein the base panel comprises at least one strap configured to secure an electronic device having a screen to the portable workstation cover.

In some embodiments, Cover 1 is further defined as follows.
1.1 Cover 1, further comprising a front panel which is positioned opposite the rear panel, and is further optionally parallel with the rear panel.
1.2 Cover 1 or 1.1, wherein the retaining sleeve is disposed along perimeters of one or more of the side panels, top panel, base panel, rear panel and front panel.
1.3 Any of the preceding Covers, wherein the retaining sleeve is disposed along perimeters of each of the top panel, base panel, rear panel and front panel.
1.4 Any of the preceding Covers, wherein the retaining sleeve defines a channel configured to receive the resilient support member.
1.5 Any of the preceding Covers, wherein one or more of the side panels, top panel, base panel, rear panel and front panel individually comprise a retaining sleeve disposed along perimeters of the respective panels.
1.6 Any of the preceding Covers, wherein each of the top panel, base panel, rear panel and front panel individually comprise a resilient support member received within a respective retaining sleeve.
1.7 Cover 1 or 1.1, wherein the retaining sleeve defines a channel that is continuous between the perimeters of adjacent panels, e.g., wherein the retaining sleeve defines of the side panels, top panel, base panel and rear panel.
1.8 Any of the preceding Covers, comprising a plurality of resilient support members configured to conform to perimeters of one or more of the side panels; top panel; base panel; rear panel; and front panel.
1.9 Any of the preceding Covers, comprising a first resilient support member in a first portion of the retaining sleeve disposed along the perimeter of the top panel, a second resilient support member in a second portion of the retaining sleeve disposed along the perimeter of the base panel, a third resilient support member in a third portion of the retaining sleeve disposed along the perimeter of the rear panel, and a fourth resilient support member in a fourth portion of the retaining sleeve disposed along the perimeter of the front panel.
1.10 Any of the preceding Covers, wherein each of the side panels, the top panel, the base panel and the rear panel comprise a material (e.g., an elastomeric mesh material, a non-elastomeric mesh material, an elastomeric opaque material, or a non-elastomeric opaque material) extending along a surface defined by the respective perimeters of the panels.
1.11 Any of the preceding Covers, comprising a front panel which is parallel with and positioned opposite the rear panel, wherein the front panel does not comprise a material extending along a surface defined by the perimeter of the front panel.
1.12 The preceding Cover, wherein the front panel comprises a retaining sleeve and a resilient support member contained within the retaining sleeve
1.13 Any of the preceding Covers, wherein the resilient support member is formed of a non-brittle metal, such as aluminum or steel (e.g., spring steel); a polymer; carbon (e.g., carbon fiber); or other resilient composite material.
1.14 Any of the preceding Covers, wherein the resilient support member is formed of steel (e.g., spring steel).
1.15 Any of the preceding Covers, wherein the resilient support member is formed of spring steel.
1.16 Any of the preceding Covers, wherein the cover is movable between an expanded configuration and a collapsed configuration.
1.17 Any of the preceding Covers, comprising a plurality of straps to receive one or more corresponding electronic devices.
1.18 Any of the preceding Covers, wherein the electronic device comprises a screen, e.g., wherein the electronic device is one or more of a tablet, a laptop computer, a hybrid laptop computer (i.e., a laptop computer with a removable keyboard to allow function as a tablet), a smartphone, a portable gaming system, or a monitor.
1.19 Any of the preceding Covers, wherein the electronic device is a tablet.
1.20 Any of the preceding Covers, wherein the electronic device is a laptop computer.
1.21 Any of the preceding Covers, wherein the interior volume is sized to receive a laptop computer in an open configuration.
1.22 Any of the preceding Covers, wherein the strap is disposed on an inner surface of the base panel (i.e., facing toward the interior volume).
1.23 Any of the preceding Covers, wherein the strap is disposed with one or more retaining sleeves, e.g., oppositely positioned retaining sleeves.
1.24 Any of the preceding Covers, wherein the strap is configured to fit over a surface of the electronic device (e.g., a lower surface of the laptop adjacent to the keyboard, e.g., to the rear of the keyboard).
1.25 Any of the preceding Covers, wherein the strap is elastic.
1.26 Any of the preceding Covers, wherein the strap comprises an attachment clasp (e.g., button, hook and loop, bar and loop, or velcro) such that upon connecting the attachment clasp, the strap is configured to hold the electronic device in place, and upon release of the attachment clasp, the strap is configured to release the electronic device.
1.27 Any of the preceding Covers, wherein the strap is detachable from the base panel.
1.28 Any of the preceding Covers aside from the immediately preceding Cover, wherein the strap is non-detachable from the base panel.
1.29 Any of the preceding Covers, wherein the base panel further comprises at least one binding configured to receive a front portion of the electronic device (e.g., front corner of a laptop computer), wherein the binding is disposed on an inner surface of the base panel or wherein the binding is disposed with one or more retaining sleeves, e.g., oppositely positioned retaining sleeves.
1.30 Any of the preceding Covers, wherein the base panel comprises two bindings configured to receive corresponding front corners of the electronic device (e.g., a laptop computer), wherein both bindings are disposed on an inner surface of the base or wherein the bindings are disposed with one or more retaining sleeves, e.g., oppositely positioned retaining sleeves.
1.31 Any of the preceding Covers, further comprising an aperture disposed on the rear panel.
1.32 Any of the preceding Covers, wherein an outer surface of the rear panel comprises a holster configured to receive a camera device (e.g., a cellular phone).
1.33 The preceding Cover, wherein the holster is elastic and positioned so as to align a camera on the cellular phone with an aperture disposed on the rear panel.
1.34 The preceding cover, further comprising a reinforcement pad adjacent the aperture to impart structural integrity to a portion of the rear panel to accept the camera device.

In a second aspect, the present disclosure is directed to a portable workstation cover [Cover 2] comprising:

a series of interconnected panels comprising:
two oppositely positioned side panels,
a top panel and oppositely positioned to a base panel connected to the side panels, and
a rear panel connected to each of the side panels, the top panel and the base panel; at least one resilient support member received within at least one retaining sleeve; wherein the side panels, top panel, base panel and rear panel together define an interior volume, and wherein an outer surface of the rear panel comprises a holster configured to receive a camera device, said rear panel further comprising an aperture configured to align with the camera.

In some embodiments, Cover 2 is further defined as follows.
2.1 Cover 2, further comprising a front panel which is positioned opposite the rear panel, and is further optionally parallel with the rear panel.
2.2 Cover 2 or 2.1, wherein the retaining sleeve is disposed along perimeters of one or more of the side panels, top panel, base panel, rear panel, and front panel.
2.3 Any of the preceding Covers, wherein the retaining sleeve is disposed along perimeters of each of the top panel, base panel, rear panel and front panel.
2.4 Any of the preceding Covers, wherein the retaining sleeve defines a channel configured to receive the resilient support member.
2.5 Any of the preceding Covers, wherein one or more of the side panels, top panel, base panel, rear panel and front panel individually comprise a retaining sleeve disposed along perimeters of the respective panels.
2.6 Any of the preceding Covers, wherein each of the top panel, base panel, rear panel and front panel individually comprise a resilient support member received within a respective retaining sleeve.
2.7 Any of the preceding Covers, wherein the retaining sleeve defines a channel that is continuous along the perimeters of each of the top panel, base panel, rear panel, and front panel.
2.8 Any of the preceding Covers, comprising a plurality of resilient support members configured to conform to perimeters of one or more of the side panels; top panel; base panel; rear panel; and front panel.
2.9 Any of the preceding Covers, comprising a first resilient support member in a first portion of the retaining sleeve disposed along the perimeter of the top panel, a second resilient support member in a second portion of the retaining sleeve disposed along the perimeter of the base panel, a third resilient support member in a third portion of the retaining sleeve disposed along the perimeter of the rear panel, and a fourth resilient support member in a fourth portion of the retaining sleeve disposed along the perimeter of the front panel.
2.10 Any of the preceding Covers, comprising a first resilient support member in a first retaining sleeve disposed along the perimeter of the top panel, a second resilient support member in a second retaining sleeve disposed along the perimeter of the base panel, a third resilient support member in a third retaining sleeve disposed along the perimeter of the rear panel, and a fourth resilient support member in a fourth retaining sleeve disposed along the perimeter of the front panel.
2.11 Any of the preceding Covers, wherein each of the side panels, the top panel, the base panel and the rear panel comprise a material (e.g., an elastomeric mesh material, a non-elastomeric mesh material, an elastomeric opaque material, or a non-elastomeric opaque material) extending along a surface defined by the respective perimeters of the panels.
2.12 Any of the preceding Covers, comprising a front panel which is parallel with and positioned opposite the rear panel, wherein the front panel does not comprise a material extending along a surface defined by the perimeter of the front panel.
2.13 The preceding Cover, wherein the front panel comprises a retaining sleeve and a resilient support member contained within the retaining sleeve.
2.14 Any of the preceding Covers, wherein the resilient support member is formed of a non-brittle metal, such as aluminum or steel (e.g., spring steel), a polymer, carbon (e.g., carbon fiber), or other resilient composite material.
2.15 Any of the preceding Covers, wherein the resilient support member is formed of steel (e.g., spring steel).
2.16 Any of the preceding Covers, wherein the resilient support member is formed of spring steel.
2.17 Any of the preceding Covers, wherein the cover is movable between an expanded configuration and a collapsed configuration.
2.18 Any of the preceding Covers, wherein the interior volume is sized to receive a laptop computer in an open configuration.
2.19 Any of the preceding Covers, further comprising at least one strap configured to secure an electronic device having a screen (e.g., a tablet, a laptop computer, a hybrid laptop computer (i.e., a laptop computer with a removable keyboard to allow function as a tablet), a smartphone, a portable gaming system, or a monitor, preferably a laptop computer) to the portable workstation cover.
2.20 Any of the preceding Covers, comprising a plurality of straps to receive one or more corresponding electronic devices.
2.21 Any of the preceding Covers, wherein the strap is disposed on an inner surface of the base panel (i.e., facing toward the interior volume).
2.22 Any of the preceding Covers, wherein the strap is disposed with one or more retaining sleeves, e.g., oppositely positioned retaining sleeves.
2.23 Any of the preceding Covers, wherein the strap is configured to fit over a lower surface of the laptop adjacent to the keyboard (e.g., to the rear of the keyboard).
2.24 Any of the preceding Covers, wherein the strap is elastic.
2.25 Any of the preceding Covers, wherein the strap is detachable from the base panel.
2.26 Any of the preceding Covers aside from the immediately preceding Cover, wherein the strap is non-detachable from the base panel.
2.27 Any of the preceding Covers, wherein the strap comprises an attachment clasp (e.g., button, hook and loop, bar and loop, or velcro) such that upon connecting the attachment clasp, the strap is configured to hold the electronic device in place, and upon release of the attachment clasp, the strap is configured to release the electronic device.
2.28 Any of the preceding Covers, wherein the base panel further comprises at least one binding configured to receive a front portion of the electronic device (e.g., front corner of a laptop computer), wherein the binding is disposed on an inner surface of the base panel or wherein the binding is disposed with one or more retaining sleeves, e.g., oppositely positioned retaining sleeves.
2.29 Any of the preceding Covers, wherein the base panel comprises two bindings configured to receive corresponding front corners of the electronic device (e.g., a laptop computer), wherein the bindings are disposed on an inner surface of the base or wherein the bindings are disposed with one or more retaining sleeves, e.g., oppositely positioned retaining sleeves.
2.30 Any of the preceding Covers, wherein the camera device is a cellular phone (e.g. a smart phone having a camera).
2.31 Any of the preceding Covers, further comprising a reinforcement pad adjacent the aperture to impart structural integrity to the portion of the rear panel to accept the camera device.

In a third aspect, the present disclosure is directed to a portable workstation cover comprising:

a series of interconnected panels comprising:
two oppositely positioned side panels,
a top panel and oppositely positioned to a base panel connected to the side panels, and
a rear panel connected to each of the side panels, the top panel and the base panel; at least one resilient support member received within at least one retaining sleeve; wherein the side panels, top panel, base panel and rear panel together define an interior volume,
   wherein the base panel comprises at least one strap configured to fit over a lower surface of a laptop computer adjacent to the keyboard and at least one binding configured to receive a front portion of the laptop computer, such that the strap and at least one binding are configured to secure the laptop computer to the portable workstation cover, and wherein an outer surface of the rear panel comprises a holster configured to receive a cellular phone, said rear panel further comprising an aperture configured to align with the camera on the cellular phone.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE FIGURES

In part, other aspects, features, benefits and advantages of the embodiments will be apparent with regard to the following description, appended claims and accompanying drawings where:

FIG. 1 illustrates a front perspective view of components of a portable workstation cover in accordance with the present disclosure. The portable workstation cover is shown in an expanded configuration.

FIG. 2 illustrates a rear perspective view of components of a portable workstation cover in accordance with the present disclosure.

FIG. 3 illustrates a front perspective view defining cross sections A and B on a portable workstation cover further shown in FIGS. 4A and 4B.

FIGS. 4A and 4B illustrate cross-sectional views of components of the presently disclosed portable workstation cover.

FIG. 5 illustrates a rear perspective view of components of a portable workstation cover in accordance with the present disclosure.

It is to be understood that the figures may not be to scale. Further, the relation between objects in a figure may not be to scale, and may in fact have a reverse relationship as to size. The figures are intended to bring understanding and clarity to the structure of each object shown, and thus, some features may be exaggerated in order to illustrate a specific feature of a structure.

### DETAILED DESCRIPTION

For the purposes of this specification and appended claims, unless otherwise indicated, all numbers used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present application. At the very least, and not as an attempt to limit the application of the doctrine of equivalents to the scope of the claims, each numerical parameter should at least be construed in light of ordinary rounding techniques.

It is noted that, as used in this specification and the appended claims, the singular forms “a,” “an,” and “the,” include plural referents unless expressly and unequivocally limited to one referent. Thus, for example, reference to “a portable workstation cover” may include one, two, three or more portable workstation covers.

It is also understood that all spatial references, such as, for example, horizontal, vertical, top, base, upper, lower, bottom, left and right, are for illustrative purposes only and can be varied within the scope of the disclosure.

As industry acceptance for remote working has increased, a new set of problems have emerged. For example, the portability of screen-containing devices such as laptop computers lends itself to the capability of working outside. There are, however, significant limitations on users who wish to work remotely in this manner. For example, working in direct sunlight increases the risk of overheating the internal electronic components of a laptop computer or other such computing devices, such as tablets. Additionally, when these devices are used outdoors, sunlight reflecting from the screen can produce a glare, prompting a user to increase brightness of the screen. This, however, exacerbates the potential of overheating, while also speeding the battery drain of the device. Without substantially altering the brightness of the screen, the contents of the screen become difficult to discern and may also lead to eye strain and fatigue.

Placing a traditional cover over such a device runs the risk of creating a pocket of hot air, and also reduces the ventilation necessary to keep the internals of the devices cool, especially for devices like laptop computers, which are actively cooled (e.g., via internal fans). Additionally, working remotely has contributed to the rise of high-definition photos of documents as being suitable replacements for scanning said documents through the use of a traditional scanner. However, taking photos that are centered and well-lit are often difficult, which creates issues with legibility and presentability.

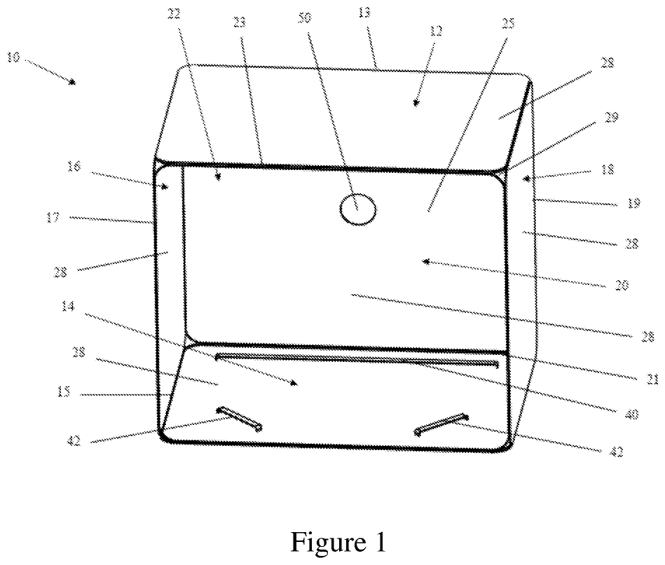

Thus, there exists a need for a simple and effective portable workstation apparatus which solves each of these problems. The following discussion includes a description of a portable workstation cover 10 to receive an electronic device, such as a laptop computer, and provide shade while working under direct sunlight. Alternate embodiments are also disclosed. Reference is made in detail to the exemplary embodiments of the present disclosure, which are illustrated in the accompanying figures. Turning to FIGS. 1-4B, there are illustrated components of a portable workstation cover 10.

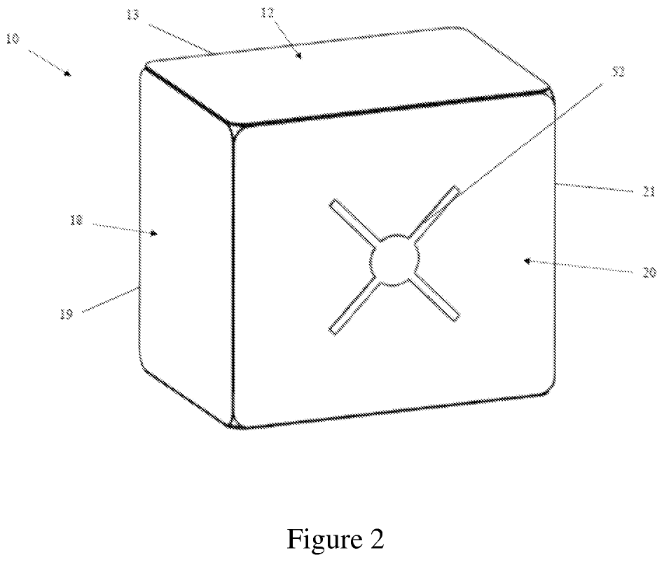

Portable workstation cover 10 includes a number of interconnected panels, as shown for example in FIG. 1. Top panel 12 runs parallel with and is positioned opposite base panel 14. In some embodiments, top panel 12 is non-parallel with base panel 14. Each of top panel 12 and base panel 14 comprise a perimeter (perimeters 13 and 15, respectively), which defines the shape of the respective panels. In various embodiments, for example, the embodiments shown in FIGS. 1 and 2, the perimeter defines a 4-sided shape, i.e., a square or rectangular shape. However, it is envisioned that the perimeter may define any of a circular, ovoid, polygonal (e.g. triangular, pentagonal or hexagonal), or irregular shape. The corners of perimeters 13 and 15 may be rounded or sharp. In various embodiments, the corners are rounded to impart structural stability to the panel. Top panel 12 and base panel 14 have the dimensions and shape, and generally correspond to the dimensions of a laptop computer in a closed configuration. That is, top panel 12 and base panel 14 have a length and width corresponding with the dimensions of a laptop computer.

Extending transversely between top panel 12 and base panel 14 are side panels 16 and 18, which may be parallel or non-parallel to one another and are situated at opposite ends of top panel 12 and base panel 14. Thus, side panels 16 and 18 are each connected to one edge of top panel 12 and one edge of base panel 14, for example by stitching, such that portable workstation cover 10 forms a cross-sectional shape of a square, rectangle or other types of quadrilaterals with top panel 12 and 14. Side panels 16 and 18 are both dimensioned so as to correspond to a depth of top panel 12 and base panel 14.

Side panels 16 and 18 are positioned opposite one another, and each comprise a perimeter, which defines the shape of the respective panels. In various embodiments, for example, the embodiments shown in FIGS. 1 and 2, perimeter 17 of panel 16 and perimeter 19 of panel 18 each define a 4-sided shape, i.e., a square or rectangular shape. However, it is envisioned that the perimeter may define any of a circular, ovoid, polygonal (e.g. triangular, pentagonal or hexagonal), or irregular shape. The corners of perimeters 17 and 19 for each of side panels 16 and 18 may be rounded or sharp. In various embodiments, the corners are rounded to impart structural stability to the panel.

Portable workstation cover 10 also includes a rear panel 20, which is positioned transversely adjacent to each of the top panel 12, base panel 14 and side panels 16 and 18. Rear panel 20 is connected to each of the top panel 12, base panel 14 and side panels 16 and 18 along their respective edges facing toward the rear of portable workstation cover 10, for example by stitching. Like the panels discussed above, rear panel 20 comprises a perimeter 21, which defines the shape of rear panel 20. In various embodiments, for example, the embodiments shown in FIGS. 1 and 2, perimeter 21 of each of rear panel 20 defines a 4-sided shape, i.e., a square or rectangular shape. However, it is envisioned that the perimeter may define any of a circular, ovoid, polygonal (e.g. triangular, pentagonal or hexagonal), or irregular shape. The corners of perimeter 21 may be rounded or sharp. In various embodiments, the corners are rounded to impart structural stability to the panel.

Portable workstation 10 may also comprise a front panel 22, which is in some embodiments parallel with and positioned opposite to rear panel 20 and transversely adjacent to each of the top panel 12, base panel 14 and side panels 16 and 18. Front panel 22 is connected to each of the top panel 12, base panel 14 and side panels 16 and 18 along their respective edges facing toward the front of portable workstation cover 10, for example by stitching. Front panel 22 comprises a perimeter 23, which defines its shape. In various embodiments, for example, the embodiments shown in FIGS. 1 and 2, perimeter 23 of front panel 22 defines a 4-sided shape, i.e., a square or rectangular shape. However, it is envisioned that the perimeter 23 may define any of a circular, ovoid, polygonal (e.g., triangular, pentagonal or hexagonal), or irregular shape. The corners of perimeter 23 may be rounded or sharp. In various embodiments, the corners are rounded to impart structural stability to the panel. Although front panel 22 may be parallel with rear panel 20, it may also be non-parallel. For example, front panel may be pitched forward such that a top side of the panel extends further forward (i.e., toward a user) than a bottom side of the panel. Alternatively, front panel may be pitched such that the bottom side extends further forward (i.e., toward a user) than the top side.

In order to impart structural rigidity to portable workstation cover 10, a plurality of panels is in communication with at least one resilient support member 32 held within a channel defined by at least one retaining sleeve 30. In various embodiments, a retaining sleeve 30 is connected to the perimeters one or more of panels 13, 15, 17, 19, 21 and 23. For example, in some embodiments retaining sleeve 30 is disposed along perimeters of each of the top panel 12, base panel 14, rear panel 20 and front panel 22. It is envisioned that some or all of panels 12, 14, 16, 18, 20, and 22 individually comprise a retaining sleeve 30 and a corresponding resilient support member 32 disposed along perimeters of the respective panels. For example, in some embodiments each of the top panel 12, base panel 14, rear panel 20 and front panel 22 comprise a retaining sleeve 30 and a corresponding resilient support member 32. In some embodiments, side panels 16 and 18 do not comprise a retaining sleeve 30 and a corresponding resilient support member 32, but rather are supported by the frame formed by the retaining sleeves 30 and resilient support members 32 of top panel 12, base panel 14, rear panel 20 and front panel 22. In other embodiments, portable workstation cover 10 comprises a single retaining sleeve 30 that is continuous along all corners of the three-dimensional shape formed by panels 12, 14, 16, 18, 20, and 22. In such an embodiment, the single retaining sleeve 30 contains a single resilient support member 32 that correspondingly extends along all corners of the three-dimensional shape formed by panels 12, 14, 16, 18, 20, and 22 through the single retaining sleeve 30.

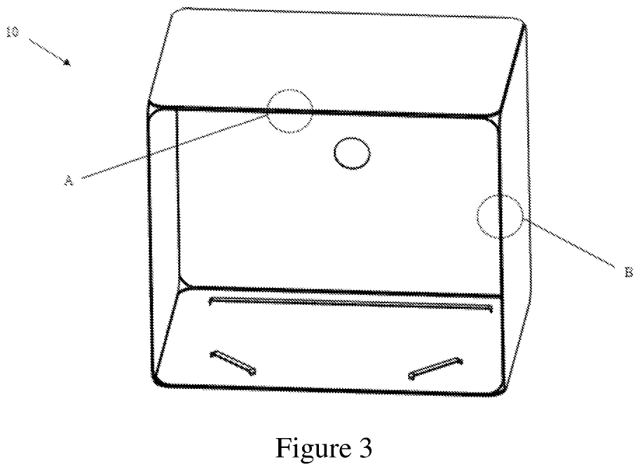

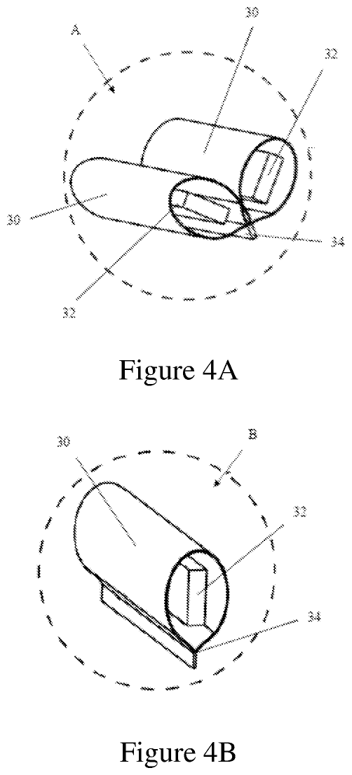

Retaining sleeve 30 may comprise a non-elastic material (e.g., fabric) fastened (e.g., stitched or adhered) along the perimeter of one or more panels of the portable workstation cover 10, such that retaining sleeve 30 forms a channel to receive a resilient support member 32. In further embodiments, retaining sleeve 30 may be mechanically fastened, fused, or glued to one or more of perimeters panels 13, 15, 17, 19, 21 and 23 to retain a corresponding resilient support member 32 in position. Thus, in one embodiment, as shown in FIGS. 3-4B, both retaining sleeve 30 and resilient support member 32 assumes the same shape defined by the perimeter of the panel to which it is secured. As shown in FIG. 1, retaining sleeve 30 and resilient support member 32 have a generally square or rectangular shape as defined by the perimeters of the panels.

As best illustrated by FIGS. 4A and 4B, one or more panels 12, 14, 16, 18, 20 and 22 may each comprise respective retaining sleeves 30, which may be connected to material 28 by line 34 (which may be stitching or adhesive) that extends along a portion or the entirety of perimeter 13, 15, 17, 19, 21 or 23 of one or more of the panels. The resilient support member 32 may be provided as one continuous loop, or may be a strip of material connected at both ends to form a continuous loop. Resilient support member 32 is formed of a flexible material that is capable of retaining its shape, even after being deformed by an applied force. Thus, resilient support member 32 is, in some embodiments, formed of flexible or coilable steel (e.g., spring steel), although other materials such as plastics may also be used. For example, the resilient support member can be any non-brittle metal (including aluminum), a polymer; carbon (e.g., carbon fiber); or other resilient composite material. Resilient support member 32 is flexible enough to allow portable workstation cover 10 to be movable between two configurations, a first configuration position such as shown in FIG. 1, or a second position in which the portable workstation cover 10 is collapsed into a size which is much smaller than its open position. While in the first configuration, portable workstation 10 is open or expanded so as to be capable of receiving an electronic device within its interior volume 25. While in the second configuration, portable workstation cover 10 is folded along the corners of adjoining panels so as to take on a flat conformation.

In some embodiments, top panel 12, base panel 14, rear panel 20 and front panel 22 each comprise a resilient support member 32 held within respective retaining sleeves 30, which comprise shapes corresponding with perimeters 13, 15, 21 and 23. Side panels 16 and 18 optionally do not comprise resilient support members, but rather are supported by the resilient support members attached to top panel 12, base panel 14, rear panel 20 and front panel 22. In other embodiments, each of panels 12, 14, 16, 18, 20 and 22 comprise individual resilient support members, which comprise shapes corresponding with perimeters 13, 15, 17, 19, 21 and 23. In some embodiments, retaining sleeve 30 extends around each of perimeters 13, 15, 17, 19, 21 and 23 such that retaining sleeve 30 forms an interconnected channel to receive a cube or cuboid shaped resilient support member 32. In such an embodiment, a singular resilient support member 32 extends along all corners of adjoining panels to provide support for portable workstation cover 10.

In an alternative embodiment, top panel 12, base panel 14, and side panels 16 and 18 each comprise a resilient support member 32 held within respective retaining sleeves 30, which comprise shapes corresponding with perimeters 13, 15, 17 and 19. Front panel 22 and rear panel 20 optionally do not comprise resilient support members, but rather are supported by the resilient support members attached to top panel 12, base panel 14, and side panels 16 and 18.

Each of top panel 12, base panel 14, side panels 16 and 18 and rear panel 20 includes a material 28 extending through the space inside their respective perimeters, and extends substantially continuously from between all sides of the respective panels. Material extends in the area defined by the perimeters of the respective panels, such that material 28 forms a continuous surface that functions substantially as a flexible wall. Notably, front panel 22 does not comprise material 28 in order to have an open front end that allows a user to access and interface with an electronic device held within portable workstation cover 10. Material 28 is secured around the perimeters of each of top panel 12, base panel 14, side panels 16 and 18 and rear panel 20, and may be fastened (e.g., sewn) into place. It is envisioned that material 28 may be elastomeric to impart flexibility or non-elastomeric to impart structural rigidity. In various embodiments, material 28 is a mesh material, e.g., a polyurethane or a nylon mesh material. Material 28 may comprise any material of sufficient strength to act as enclosure for the electronic devices to be placed in cover 10, and sufficient resiliency to recover its shape after panels 12, 14, 16, 18, 20 and 22 are repeatedly folded, twisted, unfolded and allowed to return to their original shape. Any suitable fabric may also be used. In various embodiments, material 28 is a material comprising a netting pattern, which creates the effect of partial translucency, while also allowing for maximal ventilation of the electronic device. This allows for effective shading from sunlight while outside, while also allowing some light through the cover to allow for visibility of work tasks, such as typing on a keyboard.

In certain embodiments, the fineness of the mesh pattern is uniform for each of the panels. In other embodiments, the fineness of the mesh pattern may be varied to allow for various degrees of shading. For example, in some embodiments top panel 12 and or rear panel 20 may have a finer mesh pattern than side panels 16 and 18 and base panel 20 to minimize overhead sunlight. In some embodiments, side panels 16 and 18 may be solid and continuous material that is minimally translucent or completely opaque to ensure privacy. For clarity, the material 28 on any of panels 12, 14, 16, 18, 20 and 22 may be translucent or opaque.

In further embodiments, portable workstation cover 10 comprises corner supports 29, which are attached to and held taut at the corners of adjoining panels. Corner supports 29 are made from strong, lightweight materials and may include woven fabrics, cloth, sheet fabrics, straps, nylon, string, rope or films. In some embodiments, corner supports 29 are made from the same mesh material as material 28. Corner supports 29 function to provide the portable workstation cover 10 with a pre-defined configuration, e.g. an open configuration which may take a cube or cuboid shape.

Together, panels 12, 14, 16, 18 and 20 form a three-dimensional shape defining an interior volume 25. In various embodiments, the three-dimensional shape formed by the panels is a cube or cuboid shape configured to receive an electronic device, such as a laptop computer in an open configuration.

Portable workstation cover 10 is configured to allow a user to access an electronic device confined within interior volume 25. The front-facing edges of top panel 12, base panel 14, and side panels 16 and 18, i.e., the edges of those panels positioned opposite rear panel 20, define an opening into interior volume 25. Interior volume 25 is sized to accommodate an electronic device which has a screen. For example, the present portable workstation cover 10 may be configured to receive any electronic device comprising a screen, for example, a laptop computer, a tablet, a hybrid laptop computer (i.e., a laptop computer with a removable keyboard to allow function as a tablet), a smartphone, a portable gaming system or a monitor. Interior volume 25 may further be sized to accommodate more than one electronic device (e.g., a laptop computer and one or more monitors). The electronic device may comprise a keyboard that is attachable, detachable or capable of being wirelessly connected to the electronic device having a screen. In various embodiments, interior volume 25 is sized so as to allow a user to interface with a laptop computer, for example, through use of the keyboard and/or trackpad, while viewing the screen.

In various embodiments, portable workstation cover 10 is adapted to secure an electronic device to base panel 12. For example, in various embodiments, base panel 14 comprises a strap 40 configured to receive an electronic device comprising a screen, e.g., a laptop computer, a tablet, a hybrid laptop computer (i.e., a laptop computer with a removable keyboard to allow function as a tablet), a smartphone, a portable gaming system, or a monitor. For example, strap 40 may be elastic to stretch over a base of a laptop computer and provide a secure attachment between the laptop computer and the base panel 14. In other embodiments, strap 40 may comprise a clasp, button, loop and bar, or hook and loop positioned at a portion (e.g., a central portion) of strap 40, such that separating one end of strap 40 from the other allows a user to put a laptop computer or tablet into place, and re-securing one end of strap 40 to the other allows the user to secure the laptop computer to base panel 14. Strap 40 may be permanently affixed to base panel 14. For example, strap 40 may be stitched, glued, or tied to base panel 14 at either end. Alternatively, strap 40 may be removable from base panel 14. For example, strap 40 may pass through holes in base panel 14 and may be held loosely by knots at either end that prevent it from being removed base panel 14 without undoing the knots. In further embodiments, strap 40 is attached directly to opposing edges of base panel 14 (i.e., a first edge adjacent side panel 16 and a second edge adjacent side panel 18). For example, strap 40 may be stitched or otherwise affixed to the retaining sleeve 30 of base panel 14.

In various embodiments, portable workstation cover 10 further comprises at least one binding configured to work in tandem with strap 40 to secure the electronic device to portable workstation 10. For example, at least one binding 42 may be positioned on an inner-facing surface of base panel 14 to secure a corner of the electronic device (e.g., a front facing corner of the base on a laptop computer). In a preferred embodiment, portable workstation cover 10 comprises two bindings positioned to secure respective front-facing (i.e., user-facing) corners of a laptop computer. For clarity, the front-facing corners of a laptop computer are intended to refer to the corners of a laptop base which are positioned opposite the laptop's hinges. Bindings 42 are configured relative to strap 40 such that once in place, the base of a laptop computer will be secured to portable workstation 10 at the rear-facing end (i.e., end facing away from the user; the end at which the hinges are located) by strap 40 and at the front-facing end by bindings 42. Although in certain embodiments, bindings 42 are used together with strap 40 to secure the device in place, it is contemplated that in certain embodiments, bindings 42 or strap 40 may be used in the absence of the other to secure the device in place.

The at least one binding 42 may be permanently affixed to base panel 14. For example, binding 42 may be stitched, glued, or tied to base panel 14 at both ends of the at least one binding 42. Alternatively, binding 42 may be removable from base panel 14. For example, binding 42 may pass through holes in base panel 14 and may be held loosely by knots at either end that prevent it from being removed base panel 14 without undoing the knots. In further embodiments, the at least one binding 42 is attached directly to adjacent edges of base panel 14 (e.g., a first edge adjacent front panel 22 and a second edge adjacent either side panel 16 or side panel 18). For example, binding 42 may be stitched or otherwise affixed to the retaining sleeve 30 of base panel 14.

Portable workstation cover 10 may further comprise openings in one or more of panels 12, 14, 16, 18, and/or 20 to allow passage of cables to the interior volume.

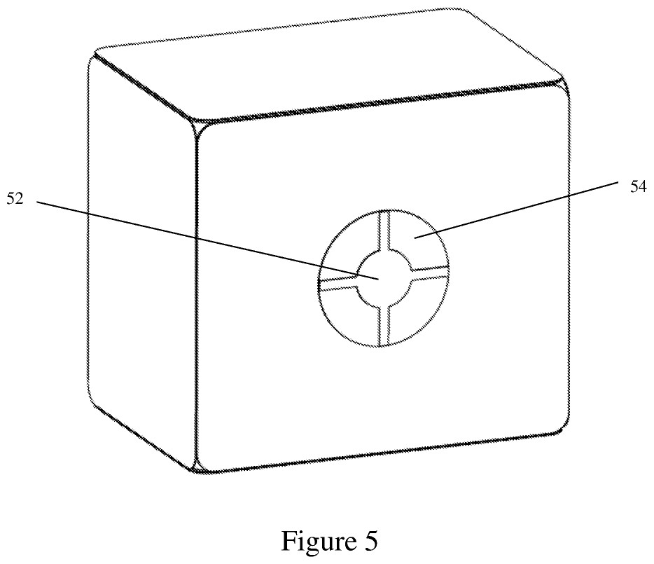

In some embodiments, portable workstation cover 10 further comprises an aperture 50 positioned at a central portion of rear panel 20, which is sized to allow an unobstructed view into interior volume 25 for a camera positioned adjacent to aperture 50. Aperture 50 may comprise a hole in rear panel 20, and is affixed (e.g., through stitching) around the perimeter of aperture 50 to impart structural integrity and/or strength thereto. Aperture 50 may comprise any shape, such as a circle, oval, square, triangle, other polygonal shapes, or irregular shapes. Portable workstation cover 10 further comprises a holster 52 positioned to secure a camera or a camera-containing device (i.e., a cellular phone) to an outer-facing surface (i.e., surface oppositely facing interior volume 25) of rear panel 20. Holster 52 is positioned such that the lens of the camera device is aligned with aperture 50. For example, aperture 50 may be offset from holster 52 to accommodate the camera on a cellular phone, which may be positioned toward a corner of the phone. In other words, aperture 50 and holster 52 may be positioned relative to one another such that when a cellular phone is placed into holster 52, the camera of the cellular phone is aligned with aperture 50 to allow photos to be taken of items, e.g., documents, placed within interior volume 25. As shown in FIG. 5, portable workstation cover further comprises a reinforcement pad 54 to increase stability for the camera-containing device. The reinforcement pad 54 is affixed to material 28 of rear panel 20. For example, reinforcement pad 54 may be stitched, glued, or otherwise affixed to the outer surface of rear panel 20. Reinforcement pad 54 is comprised of a rigid or semi-rigid (i.e., foldable, pliable, and/or twistable) material to impart structural integrity to the portion of rear panel 20 surrounding aperture 50 to strongly secure the camera containing device to portable workstation cover 10.

In use, portable workstation cover 10 can be folded and collapsed into a compact configuration for storage. Starting from the open (i.e., expanded) configuration, any two opposite corners are pressed in toward one another. For example, a user may place inward force on the corner adjoining front panel 22 and top panel 12 and the corner adjoining base panel 14 and rear panel 20 until portable workstation 10 collapses and the opposite corners come into contact with one another. Then the user folds cover 10 along the corners that have been brought into contact. Upon folding, portable workstation 10 is moved to a collapsed configuration having an overall reduced size to facilitate the portability of the cover. Optionally, while in the collapsed configuration, portable workstation cover may be twisted so as to form a rounded coil to further reduce its size. Thus, portable workstation cover 10 can be folded and stored very quickly using the steps. While in the collapsed configuration, this process may be reversed to move the portable workstation cover 10 from the collapsed position to the open or expanded position.

While in the open configuration, a user may secure an electronic device, such as a laptop computer to the interior of the portable workstation cover. Upon placing the laptop within the confines of interior volume 25, the user can open the laptop (i.e., unfold the laptop to separate the screen from the base containing the keyboard and trackpad) and slide the base into strap 40. In certain embodiments, this can be done by stretching strap 40 over the base of the laptop and sliding the laptop forward so that the strap secures a portion of the laptop base adjacent to the rear hinges to the base panel 14. In alternative embodiments, strap 40 may be opened by unhooking a clasp or via unbuttoning and subsequently secured at the appropriate position over a laptop base. Once strap 40 is in place, bindings 42 are placed over the corresponding front corners of the laptop base. The laptop is accessible to the user through front panel 22, which does not contain any mesh extending within its defined area.

In still further embodiments, the present disclosure provides for the ability to take well-aligned photos of documents. While in the open or expanded configuration, portable workstation cover 10 is placed on a surface with front panel 22 facing downward and rear panel 20 facing upward. A document to be photographed is then placed under cover 10. As front panel 22 does not contain any material 28, the document is visible through aperture 50. A camera device such as a cellular phone is placed into holster 52 and the camera lens is aligned with aperture 50. A user may adjust the orientation of the document as necessary to achieve optimal alignment and lighting. Subsequently a photo is taken while both the document and the camera device are stationary.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A portable workstation cover comprising:
a series of interconnected panels comprising:
two oppositely positioned side panels,
a top panel and oppositely positioned to a base panel connected to the side panels, and
a rear panel connected to each of the side panels, the top panel and the base panel;
at least one resilient support member received within at least one retaining sleeve;
wherein the side panels, top panel, base panel and rear panel together define an interior volume, and wherein the base panel comprises at least one strap configured to secure an electronic device having a screen to the portable workstation cover.

2. The portable workstation cover according to claim 1, further comprising a front panel which is positioned opposite the rear panel.

3. The portable workstation cover according to claim 2, comprising a plurality of resilient support members configured to conform to perimeters of one or more of the side panels; top panel; base panel; rear panel; and front panel.

4. The portable workstation cover according to claim 2, wherein one or more of the side panels, top panel, base panel, rear panel and front panel individually comprise a retaining sleeve disposed along perimeters of the respective panels.

5. The portable workstation cover according to claim 2, wherein each of the top panel, base panel, rear panel and front panel individually comprise a resilient support member received within a respective retaining sleeve.

6. The portable workstation cover according to claim 2, wherein each of the side panels, the top panel, the base panel and the rear panel comprise a material extending along a surface defined by the respective perimeters of the panels, wherein the front panel does not comprise the material.

7. The portable workstation cover according to claim 1, wherein the resilient support member is formed of non-brittle metal, such as aluminum or steel; a polymer; carbon; or other resilient composite material.

8. The portable workstation cover according to claim 1, wherein the electronic device is one or more of a tablet, a laptop computer, a hybrid laptop computer, a smartphone, a portable gaming system, or a monitor.

9. The portable workstation cover according to claim 1, wherein the strap is elastic.

10. The portable workstation cover according to claim 1, wherein the strap comprises an attachment clasp such that upon connecting the attachment clasp, the strap is configured to hold the electronic device in place, and upon release of the attachment clasp, the strap is configured to release the electronic device.

11. The portable workstation cover according to claim 1, wherein the base panel further comprises at least one binding configured to receive a front portion of the electronic device.

12. The portable workstation cover according to claim 1, further comprising an aperture disposed on the rear panel and a holster on the outer surface of the rear panel configured to receive a camera device.

13. A portable workstation cover comprising:
a series of interconnected panels comprising:
two oppositely positioned side panels,
a top panel and oppositely positioned to a base panel connected to the side panels, and
a rear panel connected to each of the side panels, the top panel and the base panel;
at least one resilient support member received within at least one retaining sleeve;
wherein the side panels, top panel, base panel and rear panel together define an interior volume, and wherein an outer surface of the rear panel comprises a holster configured to receive a camera device, said rear panel further comprising an aperture configured to align with the camera.

14. The portable workstation cover according to claim 13, further comprising a front panel which is positioned opposite the rear panel.

15. The portable workstation cover according to claim 14, comprising a plurality of resilient support members configured to conform to perimeters of one or more of the side panels; top panel; base panel; rear panel; and front panel.

16. The portable workstation cover according to claim 14, wherein each of the top panel, base panel, rear panel and front panel individually comprise a resilient support member received within a respective retaining sleeve.

17. The portable workstation cover according to claim 14, wherein each of the side panels, the top panel, the base panel and the rear panel comprise a material extending along a surface defined by the respective perimeters of the panels, wherein the front panel does not comprise the material.

18. The portable workstation cover according to claim 13, wherein the electronic device is one or more of a tablet, a laptop computer, a hybrid laptop computer, a smartphone, a portable gaming system, or a monitor.

19. The portable workstation cover according to claim 13, wherein the base panel comprises a strap configured to secure an electronic device having a screen to the portable workstation cover.

20. The portable workstation cover according to claim 13, wherein the base panel further comprises at least one binding configured to receive a front portion of a laptop computer, wherein the binding is disposed on an inner surface of the base panel.
